(19) United States
(12) Patent Application Publication
(10) Pub. No.: US 2025/0350692 A1
(43) Pub. Date: Nov. 13, 2025

(54) IMAGE PROCESSING APPARATUS, METHOD, AND NON-TRANSITORY COMPUTER READABLE STORAGE MEDIUM

(71) Applicant: CANON KABUSHIKI KAISHA, Tokyo (JP)

(72) Inventor: YUSUKE KOBANA, Kanagawa (JP)

(21) Appl. No.: 19/201,191

(22) Filed: May 7, 2025

(30) Foreign Application Priority Data
May 10, 2024 (JP) 2024-076949

(51) Int. Cl. H04N 1/00; G06V 10/94; G06V 30/19; H04N 1/44

(52) U.S. Cl. CPC H04N 1/00482; G06V 10/95; G06V 30/19; H04N 1/00244; H04N 1/00498; H04N 1/00824; H04N 1/4486; H04N 2201/0094

(57) ABSTRACT

An image processing apparatus includes a scanner, at least one processor, and at least one memory that is in communication with the at least one processor, wherein the at least one memory stores instructions for causing the at least one processor and the at least one memory to receive a capability request from an information processing apparatus via a network, and transmit, to the information processing apparatus, a response of capability information including information about a function provided in scan processing executed using the scanner. Data relating to a character recognition function is included in the capability information based on at least any one of an installation status of license data for the character recognition function for image data, an activation status of the character recognition function, and a setting value relating to a support language, on the image processing apparatus.

### BACKGROUND

### Field of the Disclosure

The present disclosure relates to a technique in an image processing apparatus that executes scan processing in response to a request from a client terminal.

### Description of the Related Art

Conventionally, a user operates an operation panel of an image processing apparatus including a scanner, and the image processing apparatus transmits a file including image data generated by scanning a document by email or transmits the file to a file server. There are a function of performing character recognition (hereinafter, referred to as Optical Character Recognition (OCR)) on image data to incorporate the character recognition result into a file as text data and a function of encrypting a file. Hereinafter, the function of encrypting a file including image data in Portable Document Format (PDF) format is referred to as PDF encryption.

A scan application can be installed as a software program on a smartphone, as an example of a client terminal. Japanese Patent Application Laid-Open No. 2020-65129 discusses a technique in which a scan application installed on a smartphone provides a setting screen corresponding to a scanner capability acquired from a multi-function peripheral (MFP). Then, the smartphone transmits a scan request to the MFP according to the setting(s) configured by a user on the setting screen.

When a scan request is made from the scan application, a user may wish to use a function, such as OCR or PDF encryption. In such a case, the MFP notifies the scan application of a scanner capability indicating that the MFP supports a function, such as OCR or PDF encryption.

Here, for functions, such as OCR and PDF encryption, detailed settings are configured for use of the functions, the settings of which should be appropriately specified depending on the state of the image processing apparatus. Conventionally, the state of the image processing apparatus involved with a function, such as OCR or PDF encryption, is not notified to the scan application in the scanner capability notification.

Further, the scan application has not been assumed to provide an appropriate setting screen when the state of the image processing apparatus involved with a function, such as OCR or PDF encryption, is received.

### SUMMARY

According to an aspect of the present disclosure, an image processing apparatus includes a scanner, at least one processor, and at least one memory that is in communication with the at least one processor, wherein the at least one memory stores instructions for causing the at least one processor and the at least one memory to receive a capability request from an information processing apparatus via a network, and transmit, to the information processing apparatus, a response of capability information including information about a function provided in scan processing executed using the scanner. Data relating to a character recognition function is included in the capability information based on at least any one of an installation status of license data for the character recognition function for image data, an activation status of the character recognition function, and a setting value relating to a support language, on the image processing apparatus.

Further features of various embodiments will become apparent from the following description of exemplary embodiments with reference to the attached drawings.

### BRIEF DESCRIPTION OF THE DRAWINGS

FIG. 1 is a system configuration diagram according to a first exemplary embodiment.

FIG. 2 is a diagram illustrating an example of a hardware configuration of a multi-function peripheral (MFP).

FIG. 3 is a diagram illustrating an example of a hardware configuration of a client terminal.

FIG. 4 is a diagram of a software structure of the MFP.

FIG. 5 is a diagram of a software structure of the client terminal.

FIG. 6 illustrates a setting screen of a scan application according to the first exemplary embodiment.

FIG. 7 illustrates a scan completion screen of the scan application according to the first exemplary embodiment.

FIG. 8 illustrates an Optical Character Recognition (OCR) setting screen for scan processing on the MFP according to the first exemplary embodiment.

FIG. 9 illustrates a sequence of processes performed by the MFP and the client terminal according to the first exemplary embodiment.

FIG. 10 is a flowchart illustrating a process executed by the client terminal according to the first exemplary embodiment.

FIGS. 11A to 11C are diagrams illustrating communication details of pull scan according to the first exemplary embodiment.

FIGS. 12A and 12B are diagrams illustrating communication details in scanner status acquisition according to the first exemplary embodiment.

FIG. 13 is a flowchart illustrating a process executed by the MFP according to the first exemplary embodiment.

FIG. 14 is a flowchart illustrating details of a setting process relating to an OCR function executed by the MFP.

FIG. 15 illustrates a setting screen of a scan application according to a second exemplary embodiment.

FIG. 16 illustrates a Portable Document Format (PDF) encryption setting screen in pull scan on the MFP according to the second exemplary embodiment.

FIGS. 17A and 17B are diagrams illustrating communication details of pull scan according to the second exemplary embodiment.

FIG. 18 is a flowchart for an image processing apparatus according to the second exemplary embodiment.

FIG. 19 is a flowchart illustrating details of configuring PDF encryption capability settings in FIG. 18.

### DESCRIPTION OF THE EMBODIMENTS

Hereinafter, exemplary embodiments will be described with reference to the drawings.

As a first exemplary embodiment, a method will be described in which a scan application is executed by an information processing apparatus that can be a client terminal, such as a smartphone, and a setting screen is provided for a scan suitable for the state of an image processing apparatus that is a destination of a request by the scan application.

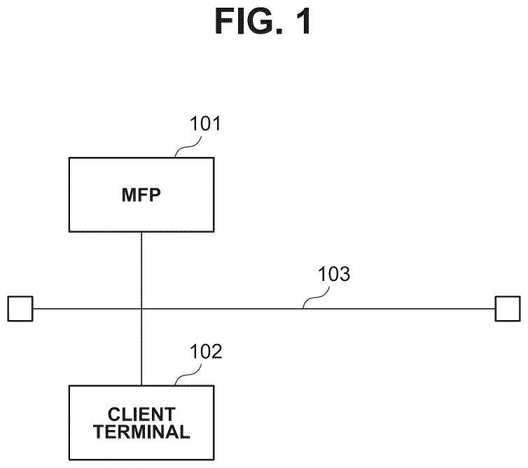

FIG. 1 illustrates a configuration example of a system including an image processing apparatus according to the first exemplary embodiment. In the system illustrated in FIG. 1, a multi-function peripheral (MFP) 101 as the image processing apparatus and a client terminal 102 are connected to each other via a network line 103. The client terminal 102 is a typical information processing apparatus, such as a personal computer (PC) or a smartphone.

Here, the scan application according to the present exemplary embodiment is assumed to be a software program for use of the scan function of the MFP 101 installed in the client terminal 102.

The scan application may be implemented as a software program incorporated in or added to an operating system of the client terminal 102.

The MFP 101 is an image processing apparatus including its print engine and a scanner, and the MFP 101 has copy and print functions. The MFP 101 has a transmission function of receiving a scan request via the network line 103 and transmitting a file including data obtained by scanning a document in response to the request via a network. The image processing apparatus to which the present exemplary embodiment can be applied may be a single-function scanner apparatus having a transmission function, other than the MFP 101.

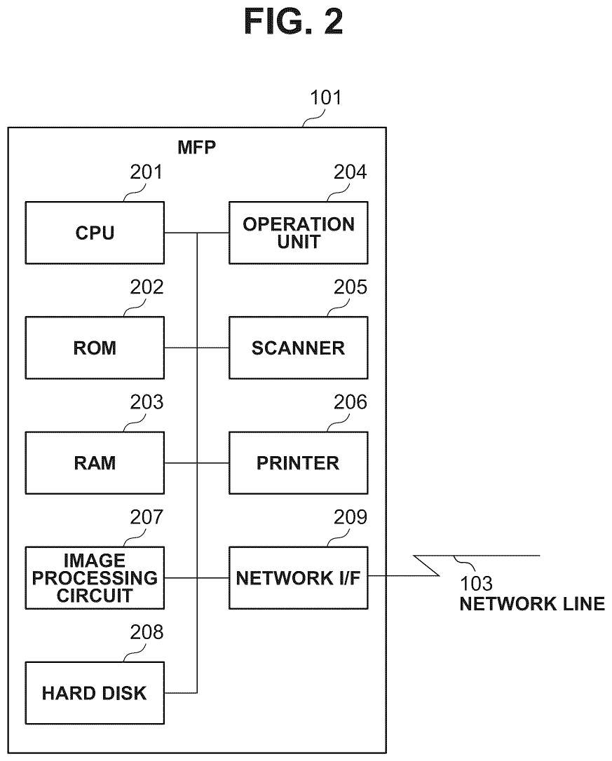

An example of a hardware configuration of the MFP 101 will be described with reference to FIG. 2. The MFP 101 includes a central processing unit (CPU) 201, a read-only memory (ROM) 202, a random access memory (RAM) 203, an operation unit 204, a scanner 205, a printer 206, an image processing circuit 207, a hard disk 208, and a network interface (I/F) 209. The CPU 201 is a control circuit that generally controls the system by using programs stored in the ROM 202 and memory as the RAM 203. The operation unit 204 is a circuit that executes user operations. The scanner 205 reads images on a document and sequentially outputs the read images page by page. The printer 206 prints images on recording media. The image processing circuit 207 includes large-capacity image memory, an image rotation circuit, a resolution scaling circuit, and an encoding/decoding circuit for, for example, Modified Huffman (MH), Modified Read (MR), Modified Modified Read (MMR), Joint Bi-level Image Group (JBIG), and/or Joint Photographic Experts Group (JPEG), and can also execute various kinds of image processing, such as shading, trimming, and masking.

The hard disk 208 is a large-capacity storage medium connected via an I/F, such as Small Computer System Interface (SCSI) and Integrated Drive Electronics (IDE). The network I/F 209 is a circuit for connecting to the network line 103. The scanner 205, the printer 206, and the image processing circuit 207 are connected to each other via a high-speed video bus different from a CPU 201 bus from the CPU 201, enabling transmission of images at high speed. In the MFP 101, the image processing circuit 207 performs image processing on images read by the scanner 205.

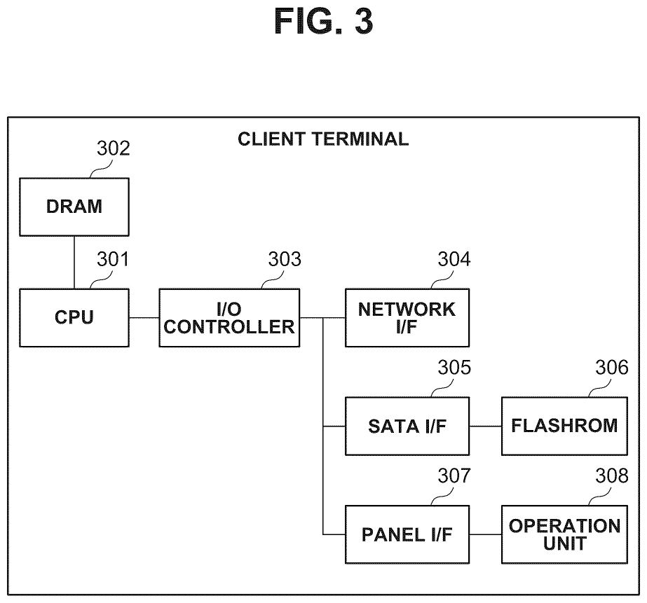

An example of a hardware configuration of the client terminal 102 will now be described with reference to FIG. 3. A CPU 301 is connected to a dynamic random access memory (DRAM) 302 via a bus. The DRAM 302 is used, by the CPU 301, as a working memory for temporarily placing program data representing operation instructions and data subject to processing when the CPU 301 performs operations. The CPU 301 is connected to an input/output (I/O) controller 303 via a bus. The I/O controller 303 is connected to a network I/F 304. The network I/F 304 is connected to a wired local area network (LAN) device, a wireless LAN device, and/or a data communication device. The CPU 301 performs communications through the network line 103 by controlling the wired LAN device, the wireless LAN device, and/or the data communication device via the network I/F 304. The I/O controller 303 performs inputs/outputs to/from various devices according to instructions from the CPU 301. The I/O controller 303 is connected to a Serial Advanced Technology Attachment (SATA) I/F 305 and is connected via the SATA I/F 305 to a flash ROM 306. Instead of the flash ROM 306, a high-capacity storage device, such as a hard disk drive (HDD), may be connected.

The CPU 301 uses the flash ROM 306 to permanently store, for example, programs including the scan application and setting values. The I/O controller 303 is connected to a panel I/F 307, and the CPU 301 controls inputs/outputs for users by using an operation unit 308 of the client terminal 102 connected via the panel I/F 307. An example of the operation unit 308 is a touch panel. The panel I/F 307 can be connected to a display device, such as a display to display, and an input device, such as a keyboard for performing inputs.

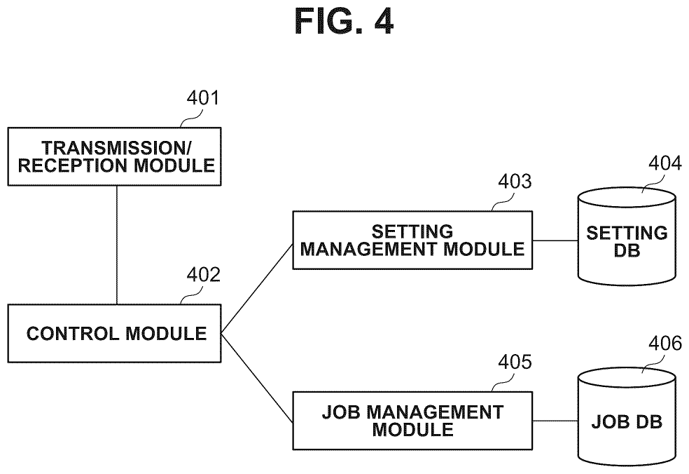

A diagram of a software structure of the MFP 101 will now be described with reference to FIG. 4. Each software module is stored in the hard disk 208 illustrated in FIG. 2 and is loaded into the RAM 203 and executed by the CPU 201.

A transmission/reception module 401 processes communications with terminals on the network line 103, such as the client terminal 102, and transmits and receives data. A control module 402 executes processing according to requests received by the transmission/reception module 401. A setting management module 403 stores information about main body settings of the MFP 101 in a setting database (DB) 404 and performs control. The main body settings refer to a plurality of setting values relating to a plurality of functions that can be provided by the MFP 101. Examples of the main body settings include an installation status of a license data (Hereinafter referred to simply as “license”) for each function that can be provided, an activation status of the function, setting values relating to language information of a character recognition function (hereinafter, referred to as an OCR function), and a version setting and algorithm setting values relating to encryption processing relating to a file encryption function (Portable Document Format (PDF) encryption function).

A job management module 405 controls various jobs, such as scanning and printing, according to instructions from the control module 402. Information about a job including scanned data and print data is stored in a job DB 406.

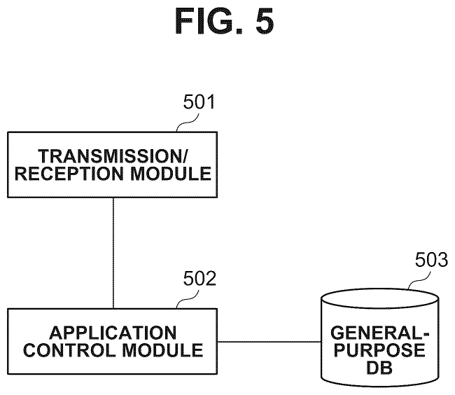

A diagram of a software configuration of the client terminal 102 will now be described with reference to FIG. 5. Each software module is stored in the flash ROM 306 illustrated in FIG. 3, and each software module is loaded into the DRAM 302 and executed by the CPU 301.

A transmission/reception module 501 processes communications with terminals on the network line 103, such as the MFP 101, and transmits and receives data. An application control module 502 controls various applications and communicates with external terminals via the transmission/reception module 501 and/or stores data in a general-purpose DB 503 as appropriate.

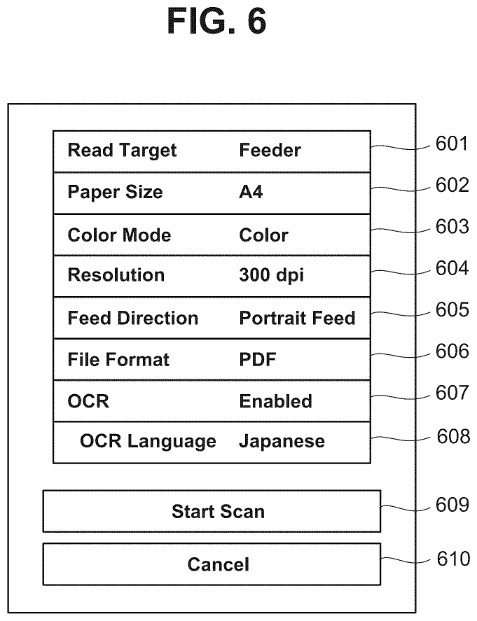

An example of a scan setting screen provided by the scan application in the client terminal 102 will now be described with reference to FIG. 6.

Buttons 601 to 608 are used for configuring read settings, and each button displays a current setting value. A user presses a button to change a setting and changes the setting via a pull-down menu or by character input. Further, based on information about a scan capability notified from the MFP 101, a selection between “displayed” and “hidden” settings of each of a plurality of buttons (setting items) respectively corresponding to a plurality of functions relating to scan processing is made, and values which can be specified in pull-down menus are displayed. The button(s) corresponding to the function(s) not supported by the MFP 101 may be displayed in a grayed-out manner, instead of being hidden.

The “Read Target” setting button 601 is used for setting a read target (a platen or a feeder). The “Paper Size” setting button 602 is used for setting a paper size (e.g., A4 or A3 size) to be read. The “Color Mode” setting button 603 is used for setting a color mode (e.g., color or monochrome) at the time of scanning. The “Resolution” setting button 604 is used for setting a resolution (e.g., 300 or 600 dot per inch (dpi)) at the time of scanning. The “Feed Direction” setting button 605 is used for setting a feed direction (portrait or landscape feed) of a document. The “File Format” setting button 606 is used for setting a file format (e.g., JPEG or PDF) of an image to be transmitted.

The “OCR” button 607 is a button (setting item) for setting a setting value indicating whether the OCR function for image data is enabled or disabled. The “OCR” button 607 can be operated only in a case where the setting of the “File Format” setting button 606 is a file format (e.g., PDF) compatible with OCR. The “OCR Language” button 608 is used for selectively setting, as a setting value, a language of characters to be recognized at the time of OCR. The “OCR Language” button 608 can be operated only in a case where the setting value of the “OCR” button 607 is specified as enabled.

A “Start Scan” button 609 is used for starting scan processing. A “Cancel” button 610 is used for closing the scan application.

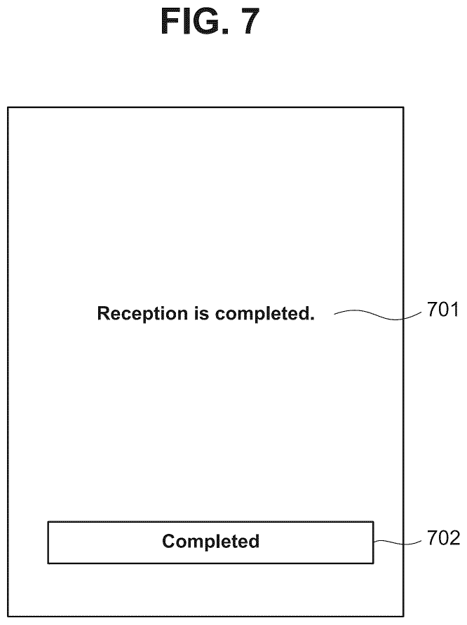

An example of a reception completion screen of the scan application will now be described with reference to FIG. 7. A message indicating that the reception is completed is displayed in a reception completion area 701. If a reception error occurs, an error message or an error code is displayed in this area. A “Completed” button 702 is used for closing the scan application.

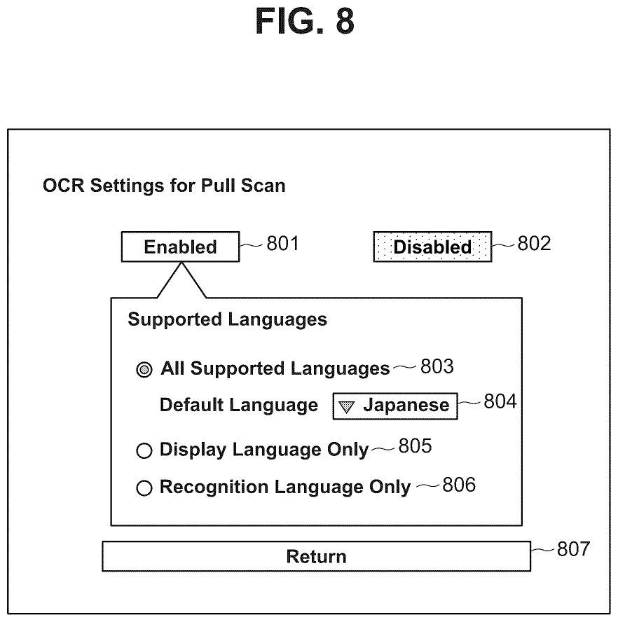

An example of a setting screen for configuring OCR settings for scan processing provided by the MFP 101 will now be described with reference to FIG. 8. In the present exemplary embodiment, an example is displayed of a setting screen relating to settings used when the MFP 101 performs pull scanning through the scan application installed on the client terminal 102. However, it is also possible to provide a setting screen for configuring settings that can be shared with various applications capable of other scan requests.

The setting screen illustrated in FIG. 8 can be displayed only in a case where the administrator has installed in advance a license (OCR license) for enabling the MFP 101 to use the OCR function.

An “Enabled” button 801 is used for enabling the OCR function. A “Disabled” button 802 is used for disabling the OCR function. The “Enabled” button 801 and the “Disabled” button 802 are in a relationship of exclusive selection. When the “Disabled” button 802 is specified, the OCR function cannot be used when a pull scan request is made from the scan application even if the OCR license has been installed on the MFP 101.

When the “Enabled” button 801 is pressed, the settings of the supported language(s) indicated by items 803 to 806 are displayed. When the “All Supported Languages” item 803 is selected, all the languages supported by the MFP 101 are returned as information about the supported languages of the OCR function in response of the MFP 101 to a scan capability request from the client terminal 102. Further, with the “All Supported Languages” item 803 selected, setting a language in the “Default Language” item 804 allows notification to the scan application of a language to be displayed as an initial value from among a plurality of supported languages in response to the scan capability request. As another setting, a part alone of the supported languages may be set to be returned.

When the “Display Language Only” item 805 is selected, a display language alone currently set in the MFP 101 is returned as information about a supported language of the OCR function in response to a scan capability request. When the “Recognition Language Only” item 806 is selected, a recognition language corresponding to a sales destination region of the MFP set in the MFP 101 is returned as information about a support language of the OCR function in response to a scan capability request. A “Return” button 807 is used for closing the setting screen.

The setting management module 403 of the MFP 101 saves a setting value according to an input operation received via the setting screen illustrated in FIG. 8 in the setting DB 404 as a main body setting of the MFP 101.

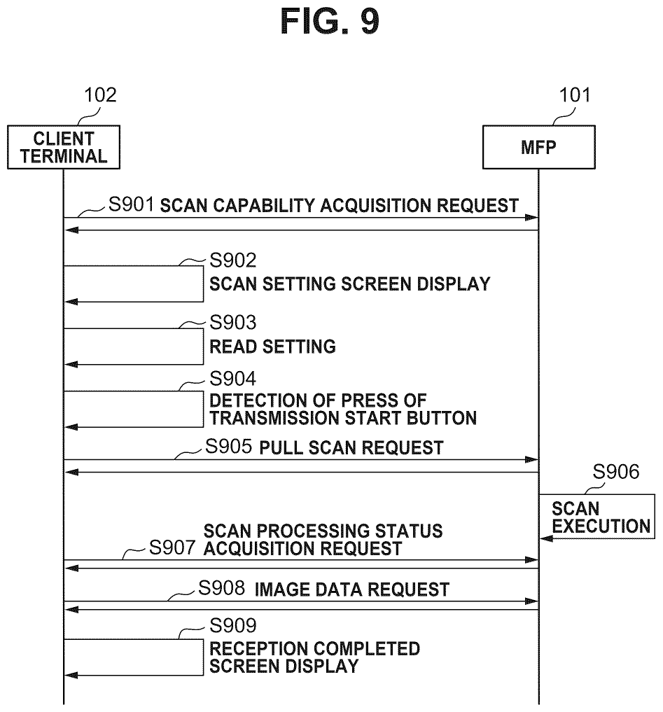

A sequence of processes performed by the MFP 101 and the client terminal 102 according to the present exemplary embodiment will now be described with reference to FIG. 9.

In step S901, the client terminal 102 makes a scan capability request to the MFP 101, and the MFP 101 returns a response including information about scan capabilities supported by the MFP 101. At this time, the scan capability relating to OCR, which is returned by the MFP 101 as part of the scan capability information, includes information based on the settings of FIG. 8 as described above.

In step S902, the scan application on the client terminal 102 displays the scan setting screen as illustrated in FIG. 6 based on the details of the response.

In step S903, the scan application on the client terminal 102 receives an input operation on setting values from the user via the scan setting screen. In step S904, the scan application on the client terminal 102 detects a press of the “Start Scan” button 609 by the user. In step S905, in response to the detection, the client terminal 102 transmits a pull scan request to the MFP 101. The MFP 101 transmits to the client terminal 102 a response indicating that the MFP 101 has received the request.

In step S906, the MFP 101 executes scan processing on a document set on the scanner glass using the scanner 205 according to the pull scan request of step S905. The scan processing generates image data and a file including the image data according to the plurality of setting values received in step S903.

In step S907, the client terminal 102 transmits a request to acquire the status of the scan processing to the MFP 101, and the MFP 101 transmits a response indicating the status of the scan processing to the request. The status of the scan processing includes at least any one of a value indicating progress, a value indicating completion, and a value indicating failure. The client terminal 102 switches processes depending on whether the scan processing is completed. In this sequence, a case will be further described where the scan processing is normally completed.

In step S908, if the scan processing is completed, the client terminal 102 requests the MFP 101 to transmit the image data generated as a result of the scan processing. Then, the MFP 101 transmits the file including the image data generated as a result of the scan processing to the client terminal 102 as a response to the request. Then, in step S909, the scan application on the client terminal 102 displays the reception completion screen as illustrated in FIG. 7.

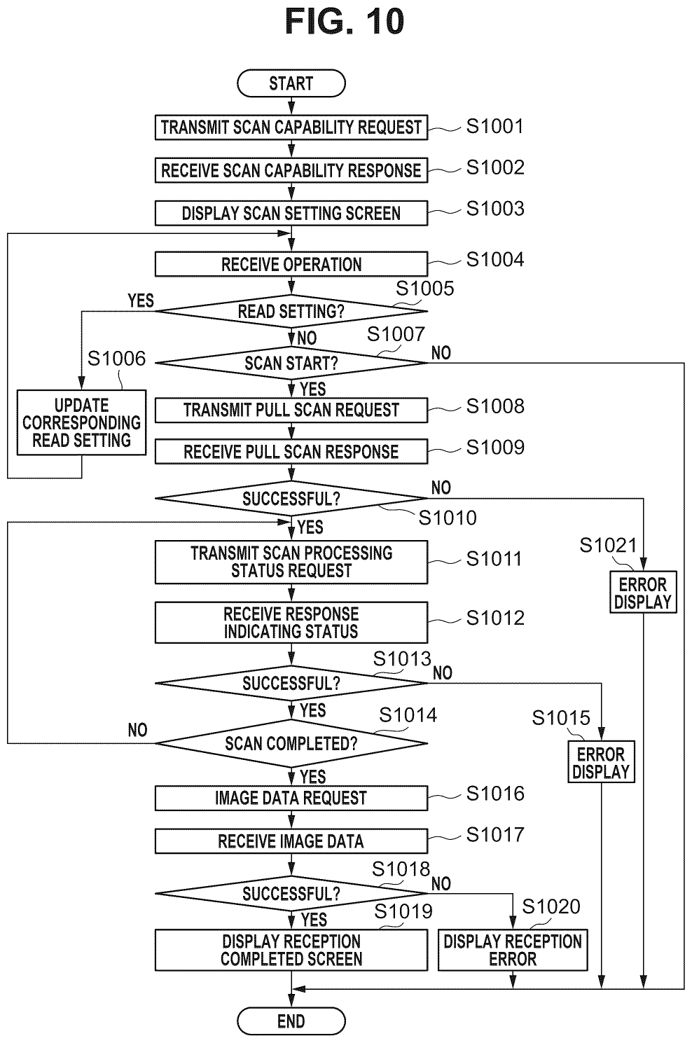

A process implemented by executing the scan application on the client terminal 102 will be described with reference to a flowchart illustrated in FIG. 10. In the present exemplary embodiment, it is assumed that Hypertext Transfer Protocol Secure (HTTPS) is used in communications and the IP address of the MFP 101 is “192.168.1.100”.

In step S1001, the client terminal 102 transmits a scan capability request to the MFP 101. The request is made to a Uniform Resource Identifier (URI) of “https://192.168.1.100/ScannerCapabilities” by using the GET method.

In step S1002, the client terminal 102 receives a scan capability response from the MFP 101.

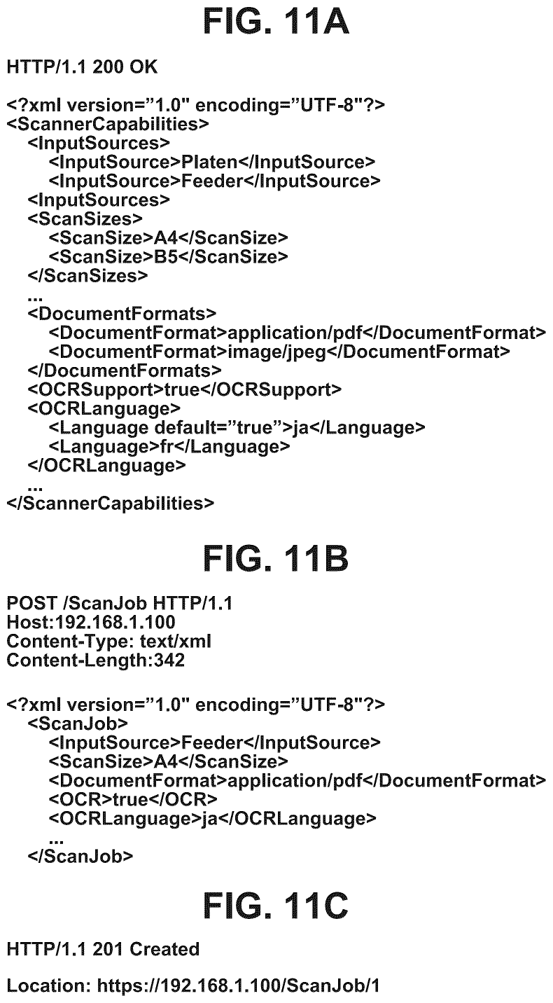

FIG. 11A illustrates an example of a part of the details of a response when the HTTPS GET request is successful.

The details of the scan capability are described under the ScannerCapabilities element in the extensible Markup Language (XML) format in the message body. The InputSources element is an element indicating a list of available read sources and has one or more InputSource elements as its child elements. The InputSource element indicates an available read source. “Platen” indicates a pressure plate, and “Feeder” indicates a feeder. The ScanSizes element is an element indicating a list of available scan sizes and has one or more ScanSize elements as its child elements. The ScanSize element indicates an available scan size, described as, for example, A4 or B5. The DocumentFormats element is an element indicating a list of available file formats and has one or more DocumentFormat elements as its child elements. The DocumentFormat element indicates available file formats using Multipurpose Internet Mail Extensions (MIME) types, and “application/pdf” indicates a PDF format, and “image/jpeg” indicates a JPEG format.

The OCRSupport element indicates whether the OCR function is available. “true” indicates that the OCR function can be specified, and “false” indicates that the OCR function cannot be specified. The case where no OCR element is included in a scan capability response may be defined as OCR specification unavailable.

The OCRLanguage element is an element indicating a list of languages that can be specified by the OCR function and has one or more Language elements as its child elements. The Language element indicates a language that can be specified by the OCR function, in a specific language code. In this case, “default=” true “ ” may be added to the attribute of a specific Language element as appropriate in order to indicate the initial value of the OCR language on the setting screen of the scan application.

In step S1003, the client terminal 102 displays the scan setting screen as illustrated in FIG. 6. The setting items and the setting values on the scan setting screen displayed at this time are based on the scan capability response received from the MFP 101 in step S1002. For example, if the OCRSupport element indicates “false” in the scan capability response received from the MFP 101, the button 607 or 608 is not displayed.

In step S1004, the client terminal 102 receives an operation from a user. In step S1005, the client terminal 102 determines whether the received operation is a read setting. If any of the buttons 601 to 608 is pressed, the client terminal 102 determines that the received operation is a read setting. If the received operation is a read setting (YES in step S1005), the processing proceeds to step S1006. In step S1006, the client terminal 102 updates the corresponding read setting. Then the processing returns to step S1004.

If the received operation is not a read setting (NO in step S1005), the processing proceeds to step S1007. In step S1007, the client terminal 102 determines whether the received operation is a scan start. If the “Start Scan” button 609 is pressed, the client terminal 102 determines that the received operation is a scan start. If the received operation is not a scan start (NO in step S1007), the process is ended.

If the received operation is a scan start (YES in step S1007), the processing proceeds to step S1008. In step S1008, the client terminal 102 transmits a pull scan request to the MFP 101.

FIG. 11B is an example of a part of the details of the pull scan request. The request is made to a URI “https://192.168.1.100/ScanJob” by using the POST method. The setting is described under the ScanJob element in the XML format in the message body. The InputSource element represents a read target, and “Feeder” indicates that the read target is a feeder. The ScanSize element represents the size of a paper sheet or paper sheets to be read, and “A4” indicates that the size of the paper sheet(s) to be read is A4. The DocumentFormat element represents a file format, and “application/pdf” indicates that the file format is the PDF format. The OCR element indicates whether the OCR function is enabled, and “true” indicates that the OCR function is enabled. The OCRLanguage element represents an OCRLanguage, and “ja” indicates Japanese.

In step S1009, the client terminal 102 receives a pull scan response from the MFP 101.

FIG. 11C is an example of a successful response to the HTTPS POST request in step S1009. “Location: https://192.168.1.100/ScanJob/1” indicates a URI for acquiring a scan image through the requested pull scan.

In step S1010, the client terminal 102 checks the content of the pull scan response to determine whether the pull scan response indicates success. If the pull scan response indicates success (YES in step S1010), the processing proceeds to step S1011. If the pull scan response does not indicate success (NO in step S1010), the processing proceeds to step S1021. In step S1021, the reception completion screen of FIG. 7 is displayed on the operation unit 308, and then the process is ended. At this time, a message indicating an error occurrence is displayed in the reception completion area 701.

In step S1011, the client terminal 102 makes a scanner status acquisition request to the MFP 101. The request is made to a URI “https://192.168.1.100/ScannerStatus” by using the GET method.

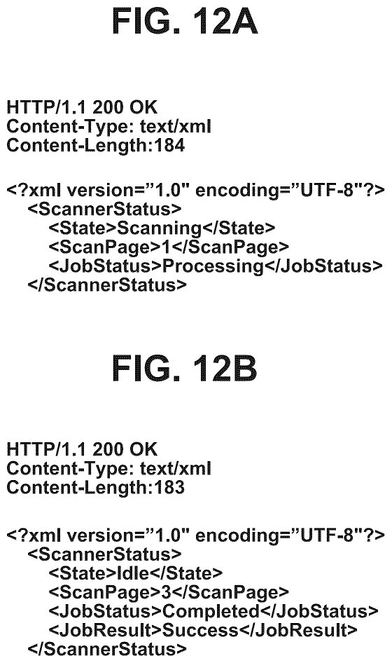

In step S1012, in response to this request, a response as illustrated in FIG. 12A or 12B is made from the MFP 101, and the client terminal 102 receives that response.

The scanner status is described in detail under the ScannerStatus element in the XML format in the message body. The State element represents the status of a scan job, and “Scanning” indicates that scan is being performed, and “Idle” indicates a standby status. The ScanPage element represents the number of pages on which scanning is complete. The JobStatus element represents the status of a scan job, and “Processing” indicates that the scan job is being processed, and “Completed” indicates that the scan job is complete. The JobResult element represents the result of a scan job, and “Success” indicates that the scan job has been normally completed.

In step S1013, the client terminal 102 determines whether the scan status response reception has been successful. If the scan status response reception has been successful (YES in step S1013), the processing proceeds to step S1014. If the scan status response reception has not been successful (NO in step S1013), the processing proceeds to step S1015. In step S1015, the reception completion screen of FIG. 7 is displayed on the operation unit 308, and the process is ended. At this time, a message indicating an error occurrence is displayed in the reception completion area 701.

In step S1014, the client terminal 102 determines whether the scan job requested in step S1008 has been completed. If the JobStatus element indicates “Completed”, it is determined that the scan job has been completed. If the scan job has not been completed (NO in step S1014), the processing returns to step S1011.

If the client terminal 102 determines that the scan job has been completed (YES in step S1014), the processing proceeds to step S1016. In step S1016, the client terminal 102 requests from the MFP 101 the image data obtained by the scan processing. This request is made to the URI returned in step S1009 by using the GET method. In step S1017, to this request, binary data (file) including the image data obtained through the scan processing is returned from the MFP 101, and the client terminal 102 receives that response. At this time, the received image data is stored in the general-purpose DB 503 of the client terminal 102.

In step S1018, the client terminal 102 determines whether the binary data (file) including the image data obtained through the scan processing has been successfully received. If the binary data has been successfully received (YES in step S1018), the processing proceeds to step S1019. In step S1019, the client terminal 102 displays the reception completion screen of FIG. 7, and the process is ended. At this time, a message indicating that the reception is completed is displayed in the reception completion area 701.

If the binary data (file) including the image data has failed to be received (NO in step S1018), the processing proceeds to step S1020. In step S1020, a screen indicating a reception error is displayed on the operation unit 308, and the process is ended.

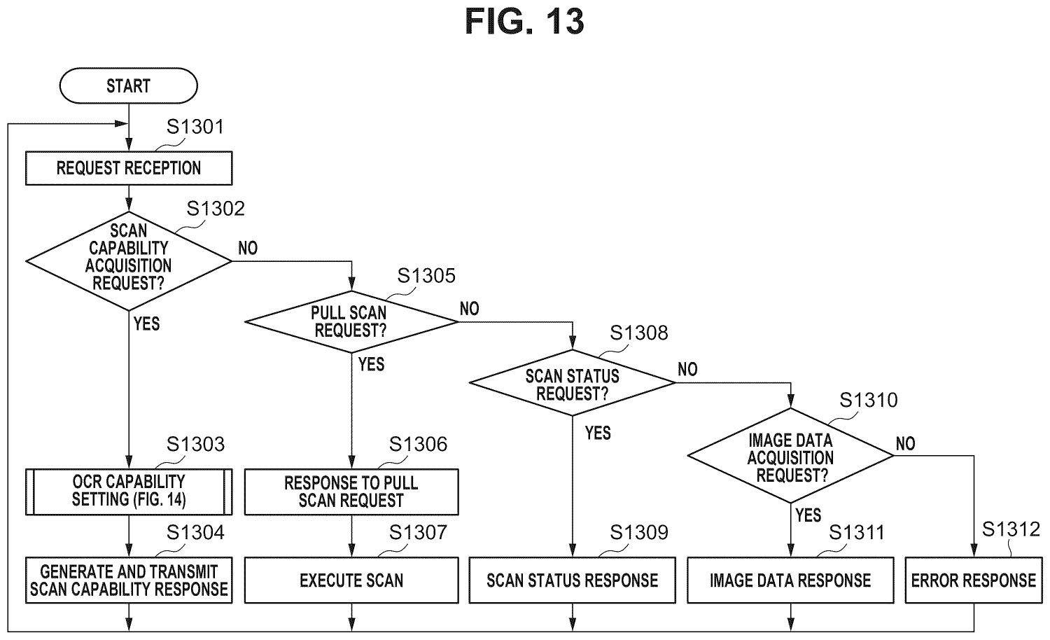

A process executed on the MFP 101 will be described with reference to a flowchart illustrated in FIG. 13.

In step S1301, the transmission/reception module 401 of the MFP 101 receives a request from the client terminal 102 via a network.

In step S1302, the control module 402 of the MFP 101 determines whether the request is a scan capability request. In a case of the GET method using which the request is made to “https://192.168.1.100/ScanerCapabilities”, the control module 402 determines that the request is a scan capability request. If the request is not a scan capability request (NO in step S1302), the processing proceeds to step S1305.

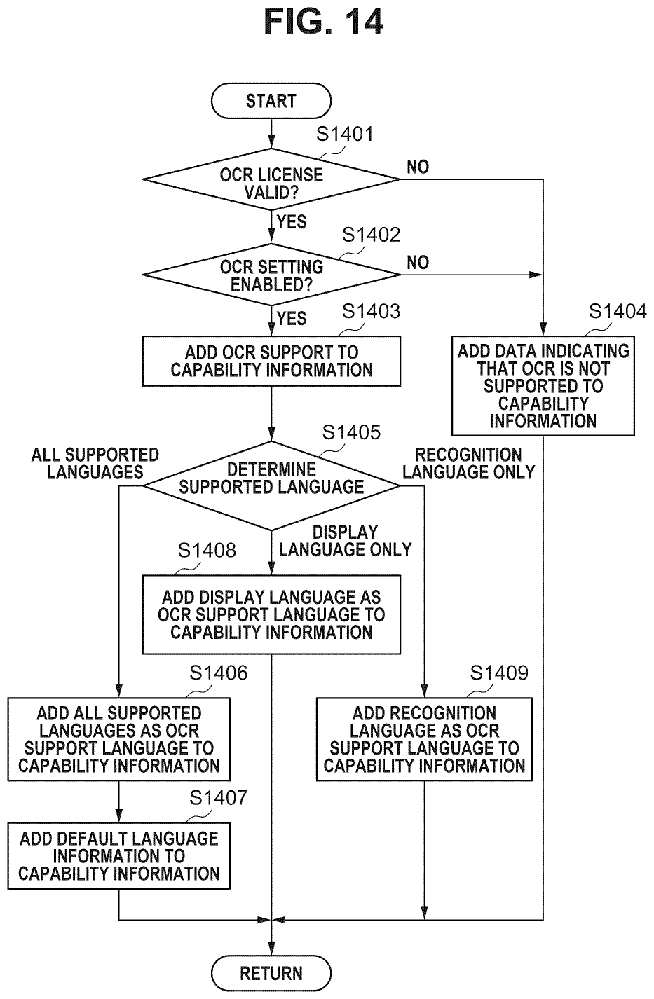

If the request is a scan capability request (YES in step S1302), the processing proceeds to step S1303. In step S1303, the control module 402 sets the OCR function to be included in the capability response. This process will be described in detail below with reference to FIG. 14.

In step S1304, the control module 402 generates the capability response as illustrated in FIG. 11A based on setting values included in the setting DB 404. Then, the transmission/reception module 401 transmits the response to the client terminal 102 as the request source. Thereafter, the processing returns to step S1301, and the control module 402 waits for the next request.

In step S1305, the control module 402 determines whether the request is a pull scan. In a case of the POST method using which the request is made to “https://192.168.1.100/ScanJob” (YES in step S1305), the control module 402 determines that the request is a pull scan. The processing proceeds to step S1306. If the request is not a pull scan (NO in step S1305), the processing proceeds to step S1308.

In step S1306, the transmission/reception module 401 transmits a pull scan response as illustrated in FIG. 11C to the request source. In step S1307, the job management module 405 executes scanning according to the read settings included in the scan request. Thereafter, the processing returns to step S1301, and the control module 402 waits for the next request.

In step S1308, the control module 402 determines whether the request received in step S1301 is a request for acquiring the status of the scan processing. In a case of the GET method using which the request is made to “https://192.168.1.100/ScannerStatus”, the control module 402 determines that the request is a request for acquiring the status of the scan processing. If the request is not a request for acquiring the status of the scan processing (NO in step S1308), the processing proceeds to step S1310.

If the request is a request for acquiring the status of the scan processing (YES in step S1308), the processing proceeds to step S1309. In step S1309, the transmission/reception module 401 makes a response as illustrated in FIG. 12A or 12B to the request source depending on the progress of the scan processing and the processing status. If the scan processing is being performed, a response as illustrated in FIG. 12A is made. If the scan job has been completed, a response as illustrated in FIG. 12B is made. Thereafter, the processing returns to step S1301, and the control module 402 waits for the next request.

In step S1310, the control module 402 determines whether the request received in step S1301 is an image data acquisition request. If this request is a request using the GET method made to the URI designated by Location of the pull scan response transmitted in step S1306, the control module 402 determines that the request is a request for acquiring an image obtained through the scan processing. If the request is not a request for acquiring an image obtained through the scan processing (NO in step S1310), the processing proceeds to step S1312.

If the request is an image data acquisition request (YES in step S1310), the processing proceeds to step S1311. In step S1311, the transmission/reception module 401 returns a file including the image data generated by the scan processing to the request source. If the image data acquisition request cannot be processed normally, an error response may be made. Thereafter, the processing returns to step S1301, and the control module 402 waits for the next request. In step S1312, the control module 402 determines that the request that cannot be handled has been received, and the transmission/reception module 401 makes an error response to the request source. Thereafter, the processing returns to step S1301, and the control module 402 waits for the next request.

The processing in step S1303 of FIG. 13 will now be described in detail with reference to a flowchart illustrated in FIG. 14.

In step S1401, the control module 402 determines whether the license for the OCR is valid with reference to the setting DB 0404. If the license for the OCR is not valid (NO in step S1401), the processing proceeds to step S1404, and if the license is valid (YES in step S1401), the processing proceeds to step S1402.

In step S1404, the control module 402 adds data indicating that the OCR function is not supported to the capability information to be responded to the scan capability request. Specifically, the “false” element is added to the OCRSupport element. In a case where the scan application on the client terminal 102 hides the OCR setting items if receiving a response not including the OCRSupport element, the control module 402 can be configured not to include the OCRSupport element itself in the capability information. Thereafter, the processing returns to the process of FIG. 13.

In step S1402, the control module 402 determines whether the setting of the OCR function indicates enabled with reference to the setting DB 404. Specifically, if the “Enabled” button 801 is set in the OCR settings of the scan application illustrated in FIG. 8, the CPU 201 determines that the setting of the OCR function indicates enabled. If the setting of the OCR function is disabled (NO in step S1402), the processing proceeds to step S1404 described above. If the setting of the OCR function indicates enabled (YES in step S1402), the processing proceeds to step S1403. In step S1403, the control module 402 adds, to the capability information, data indicating that the OCR is supported. Specifically, as illustrated in FIG. 11A, the “true” element is added to the OCRSupport element in the capability information. The “Enabled” button 801 is not essential in the process and the OCR settings in step S1402, and it is also possible to determine that the setting of the OCR function indicates enabled as long as the license for the OCR has been installed.

In step S1405, the control module 402 determines the supported language(s) of the OCR to be included as the capability information with reference to the setting DB 404. Specifically, the control module 402 makes the determination based on the setting values (803, 805, and 806) of the supported language(s) set on the setting screen illustrated in FIG. 8.

If the “All Supported Languages” item 803 is selected in FIG. 8 (ALL SUPPORTED LANGUAGES in step S1405), the processing proceeds to step S1406. In step S1406, the control module 402 adds all the supported languages to the capability information as the supported languages of the OCR. Specifically, the control module 402 adds data indicating “all supported languages” as the OCRLanguages element and the Language element as its child element illustrated in FIG. 11A.

Subsequently, in step S1407, the control module 402 adds information indicating the default language selected with the “Default Language” item 804 of FIG. 8 as a supported language of the OCR, to the capability information. Here, the control module 402 adds the default language information specified by the user with the default=“true” element illustrated in FIG. 11A. The method of adding the information indicating the default language to the capability information varies depending on the specifications of the scan application, and examples include a method of placing the default language at the beginning of a plurality of Language elements. The control module 402 can set the default language in the capability information in accordance with the specifications of the scan application. Thereafter, the processing returns to the process of FIG. 13.

If the “Display Language Only” item 805 is selected in FIG. 8 (DISPLAY LANGUAGE ONLY in step S1405), the processing proceeds to step S1408. In step S1408, the control module 402 adds a display language to the capability information as a support language of the OCR. Specifically, the control module 402 adds data indicating language information as the display language as the OCRLanguages element and the Language element as its child element illustrated in FIG. 11A. Thereafter, the processing returns to the process of FIG. 13.

If the “Recognition Language Only” item 806 is selected in FIG. 8 (RECOGNITION LANGUAGE ONLY in step S1405), the processing proceeds to step S1409. In step S1409, the control module 402 adds a recognition language to the capability information as a supported language of the OCR. Specifically, the control module 402 adds data indicating language information as the recognition language as the OCRLanguages element and the Language element as its child element illustrated in FIG. 11A.

Thereafter, the processing returns to the process of FIG. 13.

In a second exemplary embodiment, in addition to the first embodiment, a PDF encryption function that can be provided by the MFP 101 will be described. While as the second exemplary embodiment, a case will be described where the MFP 101 supports the PDF encryption function in addition to the OCR function of the first exemplary embodiment, the second exemplary embodiment is also applicable to a case where the MFP 101 supports the PDF encryption function without the OCR function.

The system configuration and the hardware configurations of the MFP 101 and the client terminal 102 are the same as those according to the first exemplary embodiment. Thus, FIGS. 1, 2, and 3 will be referred to, and the descriptions thereof will be omitted. The software configurations of the MFP 101 and the client terminal 102 are the same as those according to the first exemplary embodiment. Thus, FIGS. 4 and 5 will be referred to, and the descriptions thereof will be omitted.

The sequence illustrated in FIG. 9 according to the first exemplary embodiment is executed between the MFP 101 and the client terminal 102. The description of this will also be omitted.

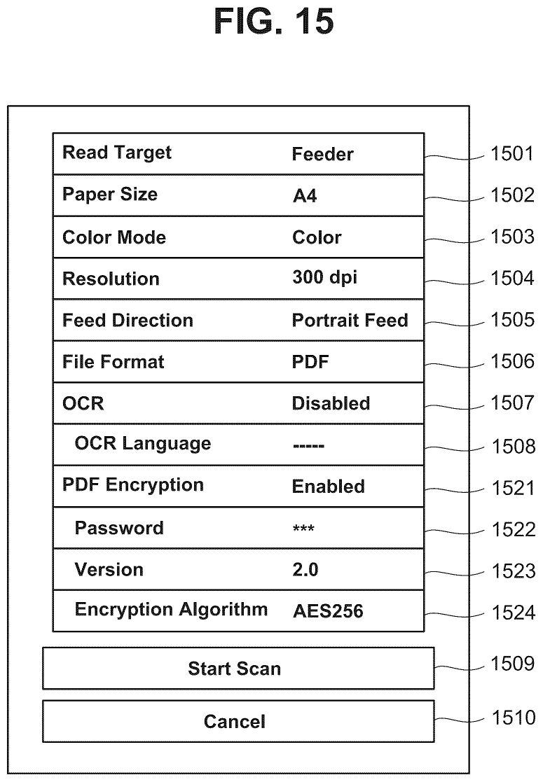

An example of a scan setting screen provided by the scan application on the client terminal 102 will now be described with reference to FIG. 15.

Buttons 1501 to 1510 and 1521 to 1524 are used for read setting, and a current setting value is displayed on each button. Further, “displayed” and “hidden” settings of each button and a setting of each button that can be specified when the button is displayed are based on the information about the scan capability notified from the MFP 101. The buttons 1501 to 1510 are the same as the buttons 601 to 610 of FIG. 6 according to the first exemplary embodiment, and thus the description thereof will be omitted.

The “PDF Encryption” button 1521 is used for setting whether to enable or disable the PDF encryption. The “PDF Encryption” button 1521 can be operated only when the setting of the “File Format” setting button 1506 is PDF.

The “Password” button 1522 is used for setting an encryption password for the PDF encryption. Here, in order to conceal the characters input as an encryption password, the input characters are each replaced with “*” and displayed. The “Password” button 1522 can be operated only when the setting of the “PDF Encryption” button 1521 indicates enabled.

The “Version” button 1523, version of the PDF Encryption, is used for setting the version of the PDF encryption specifications. The “Version” button 1523 can be operated only when the setting of the “PDF Encryption” button 1521 indicates enabled.

The “Encryption Algorithm” button 1524 is used for setting an algorithm used for the PDF encryption. The “Encryption Algorithm” button 1524 can be operated only when the setting of the “PDF Encryption” button 1521 indicates enabled.

As an application of the present exemplary embodiment, another exemplary embodiment can also be implemented in which the buttons 1507 and 1508 themselves are not displayed on the scan setting screen provided by the scan application, for example, in a case where the MFP 101 does not support the OCR function. The scan application according to the present exemplary embodiment can also provide the same reception completion screen as that of FIG. 7 according to the first exemplary embodiment.

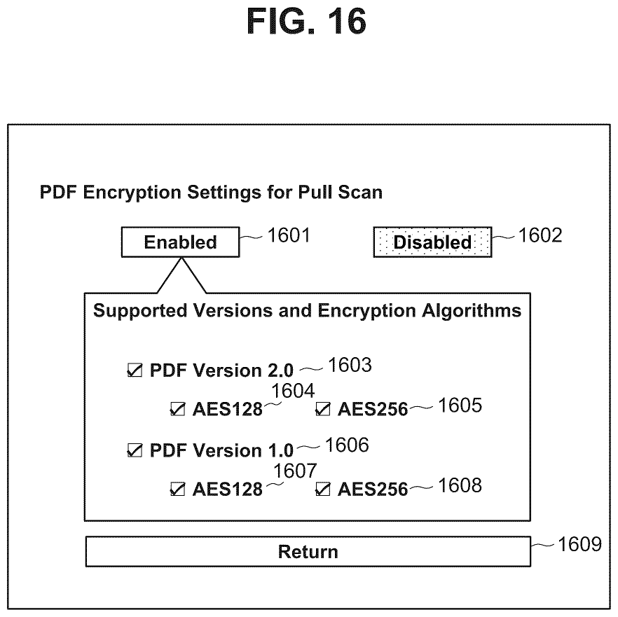

An example of a setting screen for configuring settings relating to the PDF encryption for scan processing provided by the MFP 101 will now be described with reference to FIG. 16. In the present exemplary embodiment, an example is displayed of a setting screen relating to settings used when the MFP 101 performs pull scanning from the scan application installed on the client terminal 102. However, it is also possible to provide a setting screen for configuring settings that can be shared with various applications capable of other scan requests.

The setting screen illustrated in FIG. 16 can be displayed only when the administrator has installed in advance a license (PDF encryption license) for enabling the PDF encryption function to be used on the MFP 101.

An “Enabled” button 1601 is used for enabling the PDF encryption function. A “Disabled” button 1602 is used for disabling the PDF encryption function. The “Enabled” button and the “Disabled” button are in a relationship of exclusive selection. When the “Disabled” button 1602 is specified, the PDF encryption function cannot be used when a pull scan request is made from the scan application even if the PDF encryption license has been installed on the MFP 101.

When the “Enabled” button 1601 is pressed, the settings of PDF encryption versions and encryption algorithms indicated by items 1603 to 1608 are displayed. Based on these settings, the MFP 101 includes a selected version of the PDF encryption and an encryption algorithm in a response to a scan capability request.

When the “PDF Version 2.0” item 1603 is selected, PDF Version 2.0 is returned as support version information about the PDF encryption as a response to a scan capability request. When the “PDF Version 2.0” item 1603 is selected, at least one of an “AES128” item 1604 and an “AES256” item 1605 is selected as a supported encryption algorithm.

When an “PDF Version 1.0” item 1606 is selected, PDF Version 1.0 is returned as support version information about the PDF encryption as a response to a scan capability request. When the “PDF Version 1.0” item 1606 is selected, at least one of an “AES128” item 1607 and an “AES256” item 1608 is selected as a supported encryption algorithm. A “Return” button 1609 is used for closing the setting screen.

The setting management module 403 of the MFP 101 saves the setting values according to input operations received via the setting screen illustrated in FIG. 16 in the setting DB 404 as main body settings of the MFP 101.

Here, also in the second exemplary embodiment, as a process on the client terminal 102, a process substantially similar to that of FIG. 10 according to the first exemplary embodiment is executed. However, in the second exemplary embodiment, in the processing of step S1005 shown in FIG. 10, when determining whether the received operation is a read setting, the determination is made based on the detection of whether any of the read setting buttons 1501-1524 in FIG. 15 has been pressed, instead of the read setting buttons 601-608 in FIG. 6. The response contents of the scan capability request referred to in step S1002 and the pull scan request referred to in step S1008 are also different, and will be described below.

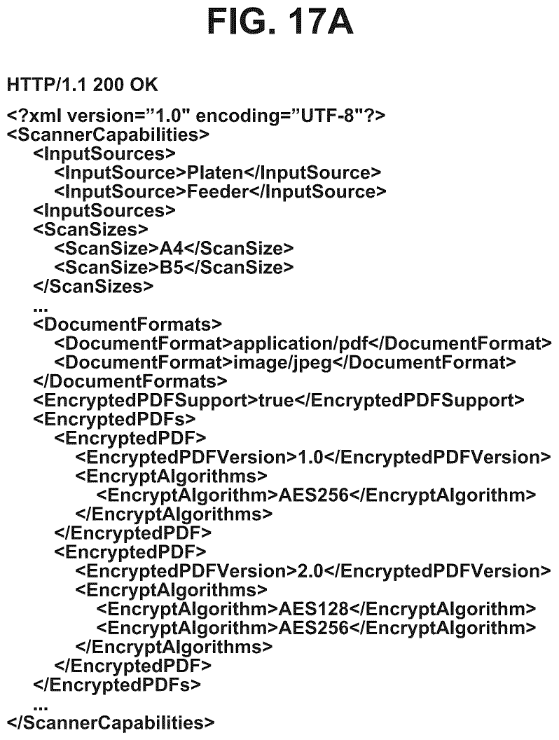

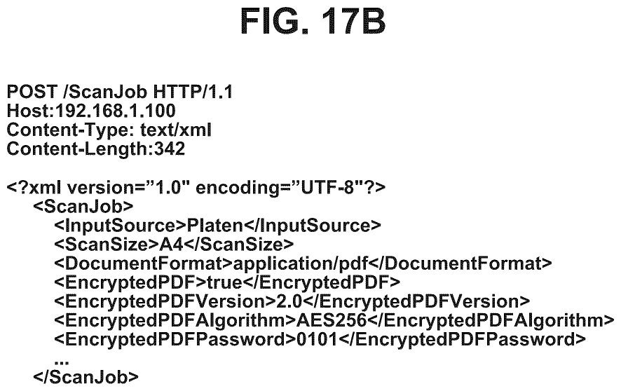

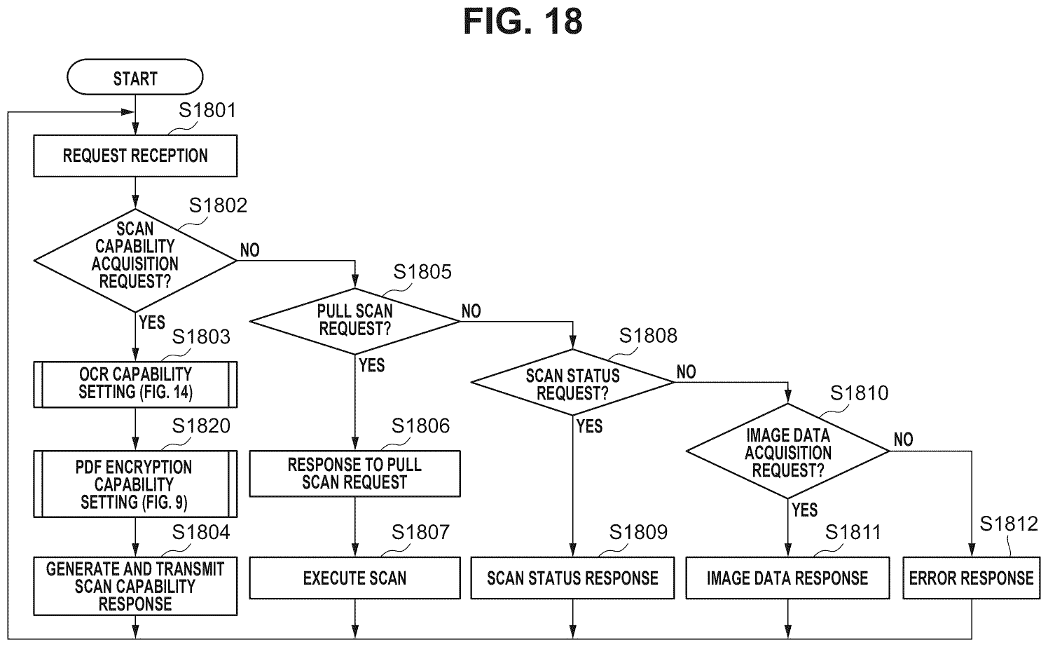

FIG. 17A is an example illustrating a part of the details of the response of the scan capability referred to in step S1002 in the present exemplary embodiment.

The InputSources, InputSource, ScanSizes, and ScanSize elements are the same as those of FIG. 11A. Thus, FIG. 11A will be referred to, and the descriptions thereof will be omitted.

The EncryptedPDFSupport element indicates whether the PDF encryption can be specified. “true” indicates that the PDF encryption can be specified, and “false” indicates that the PDF encryption cannot be specified. The EncryptedPDFSupport element may be excluded from the scan capability response to make the PDF encryption unavailable. Further, with the EncryptedPDFSupport element excluded from the scan capability response, the EncryptedPDFs element, which will be described, may be included to make the PDF encryption available.

The EncryptedPDFs element is an element indicating a list of PDF versions and encryption algorithms supported as the PDF encryption, and the EncryptedPDFs element has one or more EncryptedPDF elements as its child elements. The EncryptedPDF element is an element indicating a variation of available PDF encryptions, and the EncryptedPDF element has one EncryptedPDFVersion element and one EncryptAlgorithms element as the child elements of the EncryptedPDF element. The EncryptedPDFVersion element indicates version of the PDF encryption that can be specified. The EncryptAlgorithms element is an element indicating a list of available encryption algorithms, and the EncryptAlgorithms element has one or more EncryptAlgorithm elements as its child elements. The EncryptAlgorithm element indicates an available encryption algorithm.

FIG. 17B is an example illustrating a part of the details of the response to the pull scan request referred to in step S1008 in the present exemplary embodiment.

The InputSource, ScanSize, and DocumentFormat elements are the same as those of FIG. 11B. Thus, FIG. 11B will be referred to, and the description thereof will be omitted. The EncryptedPDF element indicates whether to generate an encrypted PDF, and “true” indicates that an encrypted PDF is generated.

The EncryptedPDFVersion element indicates a version of the PDF encryption, with “2.0” indicating version 2.0.

The EncryptedPDFAlgorithm element indicates an encryption algorithm, and “AES256” indicates the use of a 256-bit cryptographic key in the Advanced Encryption Standard (AES).

The EncryptedPDFPassword element indicates an encryption password, and “0101” indicates that the encryption password is 0101.

A process executed in the MFP 101 according to the second exemplary embodiment will now be described with reference to a flowchart illustrated in FIG. 18. The processes in steps S1801 to S1812 are the same as those in steps S1301 to S1312 of FIG. 13 according to the first exemplary embodiment, and thus the descriptions thereof will be omitted.

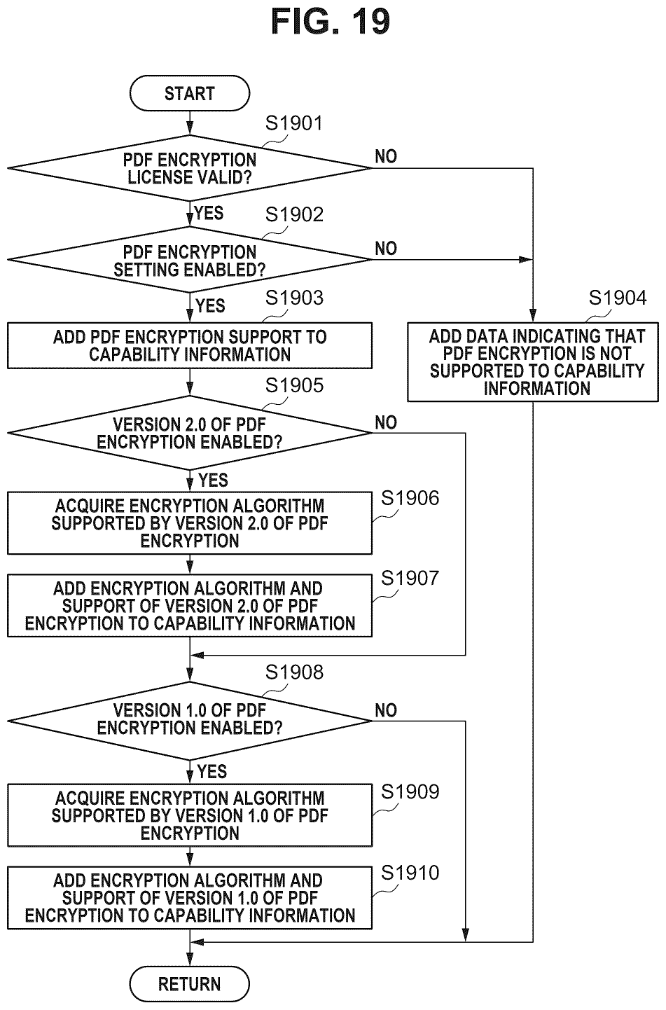

In FIG. 18, a process of step S1820 by the control module 402 is added. The control module 402 of the MFP 101 sets a PDF encryption capability to be included in the capability response. This process will be described in detail below with reference to FIG. 19.

The process in step S1820 of FIG. 18 will now be described in detail with reference to a flowchart illustrated in FIG. 19.

In step S1901, the control module 402 determines whether the license for the PDF encryption is valid with reference to the setting DB 404. If the license for the PDF encryption is not valid (NO in step S1901), the processing proceeds to step S1904, and if the license is valid (YES in step S1901), the processing proceeds to step S1902.

In step S1904, the control module 402 adds data indicating that the PDF encryption function is not supported to the capability information to be responded to the scan capability request. Specifically, the “false” element is added to the EncryptedPDFSupport element. The capability information may not include the EncryptedPDFSupport element in the capability information in accordance with the specifications of the scan application of the client terminal 102. Then the processing returns to the process of FIG. 18.

In step S1902, the control module 402 determines whether the setting of the PDF encryption function indicates enabled with reference to the setting DB 404. Specifically, the CPU 201 determines that the PDF encryption is enabled if the “Enabled” button 1601 is set in the PDF encryption settings of the scan application illustrated in FIG. 16. If the setting of the PDF encryption function is disabled (NO in step S1902), the processing proceeds to step S1904. The “Enabled” button 1601 in the process and the PDF encryption settings in step S1902 is not essential, and it is also possible to determine that the PDF encryption setting indicates enabled if the license relating to the PDF encryption has been installed.

If the setting of the PDF encryption function indicates enabled (YES in step S1902), the processing proceeds to step S1903. In step S1903, the control module 402 adds the support of the PDF encryption to the capability information. Specifically, as illustrated in FIG. 17A, the “true” element is added to the EncryptedPDFSupport element. There is a case where the scan application is configured to display the PDF encryption settings on the setting screen with the EncryptedPDFs element instead of the EncryptedPDFSupport element. In such a case, the capability information may include the EncryptedPDFs element alone without the EncryptedPDFSupport element.

In step S1905, the control module 402 determines whether version 2.0 of the PDF encryption is enabled with reference to the setting DB 404. Specifically, the control module 402 makes the determination based on whether the “PDF Version 2.0” item 1603 illustrated in FIG. 16 is selected. If the item 1603 is selected, the control module 402 determines that version 2.0 of the PDF encryption is enabled. If version 2.0 of the PDF encryption is disabled (NO in step S1905), the processing proceeds to step S1908.

If version 2.0 of the PDF encryption is enabled (YES in step S1905), the processing proceeds to step S1906. In step S1906, the control module 402 refers to the setting DB 404 to acquire an encryption algorithm supported by version 2.0 of the PDF encryption. Specifically, the control module 402 acquires the encryption algorithm selected as the “AES128” item 1604 or the “AES256” item 1605 illustrated in FIG. 16. In step S1907, the control module 402 adds the support of version 2.0 of the PDF encryption and the encryption algorithm acquired in step S1906 to the capability information. Specifically, as illustrated in FIG. 17A, the EncryptedPDFs element is added, and the EncryptedPDF element as a child element of the EncryptedPDFs element is added according to the settings of version 2.0 of the PDF encryption.

In step S1908, the control module 402 determines whether version 1.0 of the PDF encryption is enabled with reference to the setting DB 404. Specifically, the control module 402 makes the determination based on whether the “PDF Version 1.0” item 1606 illustrated in FIG. 16 is selected. If the item 1606 is selected, the control module 402 determines that version 1.0 of the PDF encryption is enabled. If version 1.0 of the PDF encryption is disabled (NO in step S1908), the processing returns to the process of FIG. 18.

If version 1.0 of the PDF encryption is enabled (YES in step S1908), the processing proceeds to step S1909. In step S1909, the control module 402 refers to the setting DB 404 to acquire an encryption algorithm supported by version 1.0 of the PDF encryption. Specifically, the control module 402 acquires the encryption algorithm selected as the “AES128” item 1607 or the “AES256” item 1608 illustrated in FIG. 16.

In step S1910, the control module 402 adds the support of version 1.0 of the PDF encryption and the encryption algorithm acquired in step S1909 to the capability information. Specifically, as illustrated in FIG. 17A, if the determination in step S1905 results in version 2.0 of the PDF encryption being enabled, the EncryptedPDFs element is added, and the EncryptedPDF element as a child element of the EncryptedPDFs element is added according to the settings of version 1.0 of the PDF encryption. Then, the processing returns to the process of FIG. 18.

The exemplary embodiments of the present disclosure each provide a mechanism in which a setting screen relating to a function, such as OCR or PDF encryption, can be appropriately provided by a scan application based on a functional state of an image processing apparatus.

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-076949, which was filed on May 10, 2024 and which is hereby incorporated by reference herein in its entirety.

What is claimed is:

1. An image processing apparatus comprising:
a scanner;
at least one processor; and
at least one memory that is in communication with the at least one processor, wherein the at least one memory stores instructions for causing the at least one processor and the at least one memory to:
receive a capability request from an information processing apparatus via a network; and
transmit, to the information processing apparatus, a response of capability information including information about a function provided in scan processing executed using the scanner,
wherein data relating to a character recognition function is included in the capability information based on at least any one of an installation status of license data for the character recognition function for image data, an activation status of the character recognition function, and a setting value relating to a support language, on the image processing apparatus.

2. The image processing apparatus according to claim 1, wherein the at least one memory further stores instructions for causing the at least one processor and the at least one memory to, in a case where the license data for the character recognition function is not installed on the image processing apparatus or the license data is installed but the character recognition function is set to be disabled, transmit a response indicating that the character recognition function is not available as the capability information to the information processing apparatus.

3. The image processing apparatus according to claim 1, wherein at least one of language information available in the character recognition function and information about a default language as the setting value relating to the support language is included in the capability information as data relating to the character recognition function.

4. The image processing apparatus according to claim 3, wherein the language information available in the character recognition function includes information indicating a display language or a language corresponding to a sales destination region of the image processing apparatus.

5. The image processing apparatus according to claim 1, wherein the capability information further includes data relating to an encryption function for a file based on at least any one of an installation status of license data for the encryption function, an activation status of the encryption function, and a setting value relating to the encryption function, on the image processing apparatus.

6. The image processing apparatus according to claim 1,
wherein a setting screen for scan processing provided by a software program for scan processing from the information processing apparatus is configured according to a content of the capability information included in the response, and
wherein the at least one memory further stores instructions for causing the at least one processor and the at least one memory to
receive a scan request including a setting value based on a specification by a user via the setting screen for scan processing from the information processing apparatus, and
transmit a file including image data generated by scan processing executed based on the scan request, to the information processing apparatus.

7. An image processing apparatus comprising:
a scanner;
at least one processor; and
at least one memory that is in communication with the at least one processor, wherein the at least one memory stores instructions for causing the at least one processor and the at least one memory to:
receive a capability request from an information processing apparatus via a network; and
transmit, to the information processing apparatus, a response of capability information including information about a function provided in scan processing executed using the scanner,
wherein data relating to an encryption function for a file is included in the capability information based on at least any one of an installation status of license data for the encryption function, an activation status of the encryption function, and a setting value relating to encryption, on the image processing apparatus.

8. The image processing apparatus according to claim 7, wherein the at least one memory further stores instructions for causing the at least one processor and the at least one memory to, in a case where the authorization for the encryption function is not installed on the image processing apparatus or the license data is installed but the encryption function is set to be disabled, transmit a response indicating that the encryption function is not available as the capability information to the information processing apparatus.

9. The image processing apparatus according to claim 7, wherein at least one of version information and encryption algorithm information supported by the encryption function as the setting value relating to the encryption is included in the capability information as data relating to the encryption function.

10. A method for an image processing apparatus including a scanner, the method comprising:
receiving a capability request from an information processing apparatus via a network; and
transmitting, to the information processing apparatus, a response of capability information including information about a function provided in scan processing executed using the scanner of the image processing apparatus,
wherein data relating to a character recognition function for image data is included in the capability information based on at least any one of an installation status of license data for the character recognition function, an activation status of the character recognition function, and a setting value relating to a support language, on in the image processing apparatus.

11. A non-transitory computer-readable medium on which is stored computer-executable instructions for making a computer execute a method for an image processing apparatus including a scanner, the method comprising:
receiving a capability request from an information processing apparatus via a network; and
transmitting, to the information processing apparatus, a response of capability information including information about a function provided in scan processing executed using the scanner of the image processing apparatus,
wherein data relating to a character recognition function for image data is included in the capability information based on at least any one of an installation status of license data for the character recognition function, an activation status of the character recognition function, and a setting value relating to a support language, on the image processing apparatus.
